(19) United States
(12) Patent Application Publication
(10) Pub. No.: US 2025/0380637 A1
(43) Pub. Date: Dec. 18, 2025

(54) SELF-PROPELLED MOWER

(71) Applicant: Zhejiang Dobest Power Tools Co., Ltd., Yongkang (CN)

(72) Inventors: Xiaohua Huang, Lishui (CN); Peng Huang, Lishui (CN); Min Wang, Lishui (CN); Xiaoliang Li, Lishui (CN); Xianxin Guo, Lishui (CN)

(21) Appl. No.: 19/017,659

(22) Filed: Jan. 12, 2025

(30) Foreign Application Priority Data
Jun. 12, 2024 (CN) 2024107541079

(51) Int. Cl. A01D 34/76; A01D 34/71; A01D 34/81; A01D 101/00

(52) U.S. Cl. CPC A01D 34/76; A01D 34/71; A01D 34/81; A01D 2101/00

(57) ABSTRACT

A self-propelled mower includes a frame, a mowing assembly, a moving assembly and a driving assembly. The driving assembly includes a driving member and a transmission mechanism, and the transmission mechanism includes a gear unit and a belt pulley unit. The gear unit is drivingly connected to an output shaft of the driving member. A power shaft of the rotating cutting blade is drivingly connected to the belt pulley unit. The gear unit is configured to transmit power provided by the driving member to the belt pulley unit through a transmission shaft. The belt pulley unit includes a first pulley, a second pulley, and a swing wheel, the first pulley and the second pulley are in transmission connection by a first synchronous belt, the swing wheel is disposed between the first and second pulleys, and the swing wheel is disposed against an outer side of the first synchronous belt.

### TECHNICAL FIELD

The disclosure relates to the technical field of mowers, and particularly to a self-propelled mower.

### BACKGROUND

A mower is a mechanical tool used for trimming lawns, and it comes in various forms. However, most mowers used by households are self-propelled. These types of mowers typically have a frame, a bottom of the frame is provided with rotating cutting blades facing towards the ground, a front of the frame is provided with moving wheels, and a rear of the frame is provided with driving wheels. When the mower is in use, a power component is activated to rotate the cutting blades rapidly, the moving wheels and the driving wheels make contact with the ground, and the user holds the push handle and pushes the mower forward to trim the grass along the way. In existing mowers, a driving assembly is mostly directly connected to the cutting blades through an output shaft for power transmission, which is convenient to install and provides direct power output. However, there are several drawbacks in practical use: when the cutting blades hit hard objects or become entangled with a large amount of debris, the cutting blades can become jammed, directly affecting the power output of the driving assembly and affecting the continuity of the mowing operation. Usually, it is necessary to shut down and restart the engine, which impacts work efficiency, and even causes damage to the driving assembly in serious cases.

### SUMMARY

Based on the above problems, the disclosure aims to provide a self-propelled mower that significantly reduces the impact of cutting blade jamming on the power output of the driving assembly, ensuring the efficiency of lawn mowing operations and preventing damage to the driving assembly.

The disclosure is achieved through the following technical solution.

A self-propelled mower includes a frame, a mowing assembly, a moving assembly and a driving assembly. The driving assembly includes a driving member and a transmission mechanism, the driving member includes an output shaft, and the transmission mechanism includes a gear unit and a belt pulley unit. The gear unit is drivingly connected to the output shaft of the driving member. The mowing assembly includes a rotating cutting blade, the rotating cutting blade is provided with a power shaft, and the power shaft of the rotating cutting blade is drivingly connected to the belt pulley unit. The gear unit is configured to transmit power provided by the driving member to the belt pulley unit through a transmission shaft. The belt pulley unit includes a first pulley, a second pulley, and a swing wheel, the first pulley and the second pulley are in transmission connection by a first synchronous belt, the swing wheel is disposed between the first pulley and the second pulley, and the swing wheel is disposed to press against an outer side of the first synchronous belt and push a first side of the first synchronous belt towards a second side of the first synchronous belt. The swing wheel is disposed on a swing arm configured to swing relative to the first pulley and the second pulley, the swing arm is provided with a tension spring, and the tension spring is configured to provide a force for the swing wheel to press against the first synchronous belt.

In an embodiment, the output shaft of the driving member is arranged horizontally, and the power shaft of the rotating cutting blade is arranged vertically. The gear unit includes a first gear and a second gear meshing with each other, and the first gear and the second gear are bevel gears. The transmission shaft is arranged vertically, the first gear is fixedly connected to the output shaft of the driving member, the second gear is fixedly disposed on an upper end of the transmission shaft, and the first pulley is fixedly disposed on a lower end of the transmission shaft.

In an embodiment, the mowing assembly includes the rotating cutting blade, the power shaft of the rotating cutting blades is rotatably assembled on a mounting plate, and the second pulley is fixedly sleeved onto the power shaft and disposed below the mounting plate.

In an embodiment, the swing arm includes a rotation end and an assembly end opposite to each other, the rotation end is rotatably assembled on the mounting plate, and the swing wheel is disposed to suspend below the assembly end. An end of the tension spring is hooked onto the assembly end, and another end of the tension spring is hooked onto the frame.

In an embodiment, a central axis of the swing wheel is parallel to a central axis of the first pulley and a central axis of the second pulley, and the swing wheel is disposed close to the first pulley.

In an embodiment, the frame includes a housing covering on the rotating cutting blade, the housing defines a mowing cavity configured for a rotary operation of the rotating cutting blade; a side wall of the housing defines a first grass outlet communicating with the mowing cavity, and a rear side of the housing defines a second grass outlet communicating with the mowing cavity.

In an embodiment, the housing is hinged with a first flip cover through an articulated shaft, the first flip cover is configured to flip back and forth between a closed position and an open position. The first flip cover covers the first grass outlet when the first flip cover is in the closed position, or the first grass outlet is connected to outside when the first flip cover is in the open position.

In an embodiment, when the first flip cover is in the open position, a slot plate is detachably assembled on the housing, the slot plate is positioned corresponding to the first grass outlet and supports the first flip cover, thereby keeping the first flip cover in the open position, and the slot plate extends to the outside and defines a slot opening facing downwards.

In an embodiment, the slot plate includes a U-shaped plate and an extending plate formed on an end of the U-shaped plate. The extending plate is superimposed on the housing, and hooks are disposed on the extending plate and hooked on the articulated shaft.

In an embodiment, a first torsion spring is disposed between the first flip cover and the housing, and the first torsion spring is configured to provide a force to keep the first flip cover in the closed position.

In an embodiment, the frame further includes an assembling jig disposed at the rear side of the housing, and the assembling jig defines a grass guiding mouth communicating with the second grass outlet. The assembling jig is hinged with a second flip cover, and the second flip cover is configured to flip back and forth between a closed position and an open position. The second flip cover covers the grass guiding mouth when the second flip cover is in the closed position, or the grass guiding mouth is communicating with the outside when the second flip cover is in the open position.

In an embodiment, when the second flip cover is in the open position, a grass collection bucket is detachably assembled on the assembling jig and supports the second flip cover, thereby keeping the second flip cover in the open position, and a grass intaking mouth of the grass collection bucket is communicated with the grass guiding mouth.

In an embodiment, a second torsion spring is disposed between the second flip cover and the assembling jig, and the second torsion spring is configured to provide a force to keep the second flip cover in the closed position.

In an embodiment, the assembling jig includes a forward leaning plate inclined towards the housing and side plates disposed on two sides of the forward leaning plate, the grass guiding mouth is defined on the forward leaning plate, and a protruding boss staggered with respect to the grass guiding mouth is disposed on the forward leaning plate.

In an embodiment, the grass collection bucket includes a flexible bag and a support frame supported on an outer edge of the flexible bag, the support frame includes a support rod abutted against an outer edge of the forward leaning plate, and hanging rods are symmetrically disposed on two sides of the support rod. A junction between the forward leaning plate and the side plates disposed on two sides of the forward leaning plate defines grooves for embedding the hanging rods.

In an embodiment, the moving assembly includes driving wheels disposed at the rear side of the housing and moving wheels disposed at a front side of the housing. The belt pulley unit further includes a third pulley in transmission connection to a driving shaft of the driving wheels, and the third pulley is drivingly connected to the first pulley through a second synchronous belt.

Compared to the related art, the beneficial effects of the disclosure are as follows.

By setting the swing wheel, the tension of the first synchronous belt can be adjusted in real-time, which eliminates the influence of the second pulley on the first pulley. During the operation of the self-propelled mower, the transmission mechanism can automatically perform self-protection when the self-propelled mower encounters hard objects to prevent damage to the assemblies, and after the self-propelled mower passes over the hard objects, the transmission mechanism can automatically return to normal operation, which has strong adaptability, the entire operation process is coherent and smooth without jamming, there is no need to frequently shut down and restart, and the work efficiency is high. Through the cooperation of the gear unit and the belt pulley unit, a cross-transmission can be achieved, making the layout of the entire driving assembly more rational and compact. By adjusting the gear ratio and pulley diameter ratio, the output torque can be adjusted to improve work efficiency. The driving wheels and the rotating cutting blades share a power source. By optimizing the structure of the transmission mechanism, the transmission mechanism can automatically protect itself and return to normal operation when the rotating cutting blade encounter the hard objects, eliminating the impact of running resistance of the rotating cutting blades on the driving wheels, and the driving wheels can always move steadily. The housing is provided with two grass outlets, and the two grass outlets can be respectively selected as a side grass outlet and a rear grass outlet according to the needs, and the grass discharging accessories are reasonably structured to be functional with the inherent structure of the mower. No additional fasteners are required, and the disassembly and assembly of the mower are convenient, making it easy to switch the grass discharge mode.

### BRIEF DESCRIPTION OF DRAWINGS

FIG. 1 illustrates a schematic structural diagram of a self-propelled mower of the disclosure.

FIG. 2 illustrates a schematic structural diagram of the self-propelled mower in another perspective of the disclosure.

FIG. 3 illustrates a schematic diagram of a driving assembly of the disclosure.

FIG. 4 illustrates a schematic structural diagram of a transmission mechanism of the disclosure.

FIG. 5 illustrates a schematic structural diagram of a bottom of a housing in the disclosure.

FIG. 6 illustrates a schematic structural diagram of an assembly structure of a slot plate in the disclosure.

FIG. 7 illustrates a schematic structural diagram of the slot plate of the disclosure.

FIG. 8 illustrates a schematic structural diagram of an assembly structure of a grass collection bucket in the disclosure.

FIG. 9 illustrates a schematic structural diagram of a support frame of the disclosure.

Description of reference numerals:
11. first gear; 12. second gear; 13. transmission shaft; 14. first pulley; 15. second pulley; 16. third pulley; 171. swing wheel; 1711. anti-detachment edge; 172. swing arm; 18. first synchronous belt; 19. second synchronous belt; 20. motor; 21. output shaft; 31. power shaft; 32. mounting plate; 33. rotating cutting blade; 41. driving wheel; 42. moving wheel; 51. housing; 511. first grass outlet; 512. second grass outlet; 52. first flip cover; 53. articulated shaft; 54. slot plate; 541. U-shaped plate; 542. extending plate; 543. hook; 55. assembling jig; 551. forward leaning plate; 5511. grass guiding mouth; 5512. protruding boss; 552. side plate; 553. groove; 56. protective shell; 57. second flip cover; 60. grass collection bucket; 61. flexible bag; 62. support frame; 621. support rod; 622. hanging rod; 70. handlebar.

### DETAILED DESCRIPTION OF EMBODIMENTS

The disclosure will be further described in conjunction with the embodiments illustrated in the attached drawings.

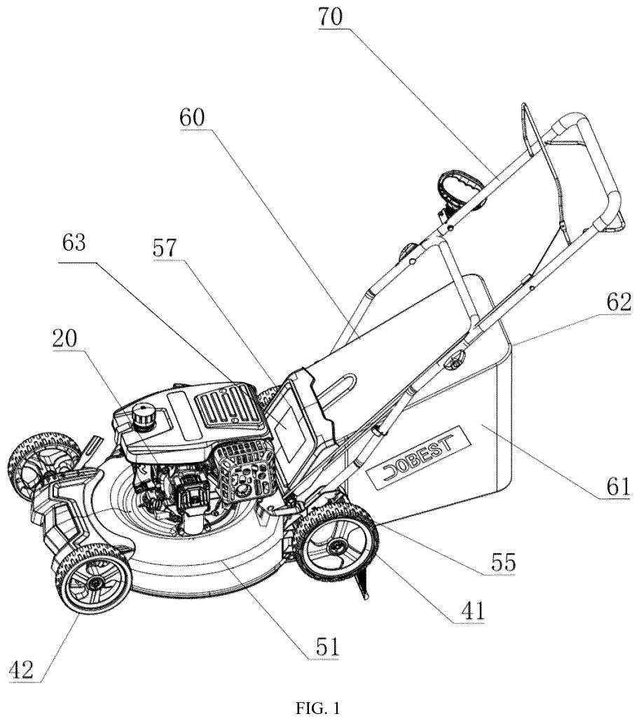

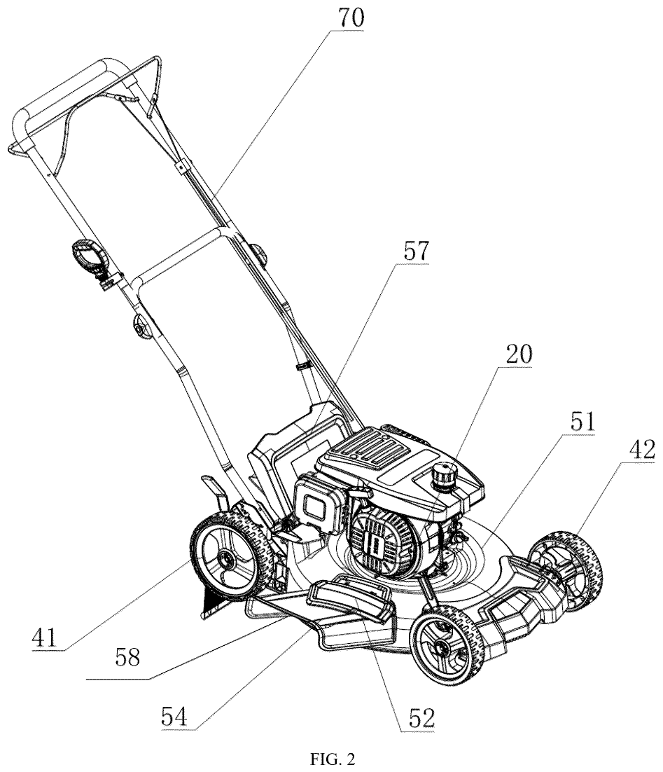

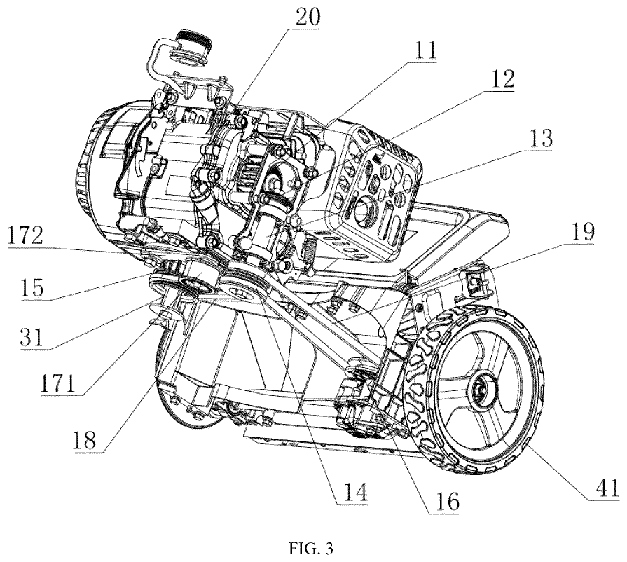

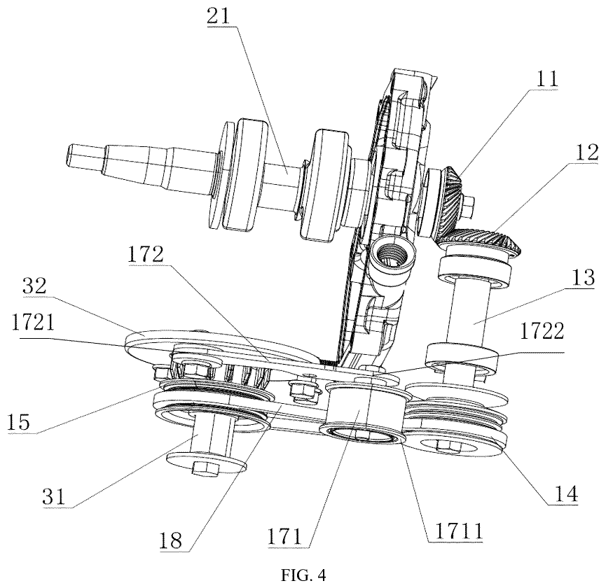

As shown in FIGS. 1-4, a self-propelled mower includes a frame, a mowing assembly, a moving assembly and a driving assembly.

The driving assembly includes a driving member and a transmission mechanism. In the embodiment, the driving member is a motor 20, and the motor 20 includes an output shaft 21, and the transmission mechanism includes a gear unit and a belt pulley unit. The mowing assembly includes a rotating cutting blade 33, and the rotating cutting blade 33 is provided with a power shaft 31. The gear unit is drivingly connected to the output shaft 21 of the motor 20, and the power shaft 31 of the rotating cutting blade 33 is drivingly connected to the belt pulley unit. The gear unit is configured to transmit power provided by the driving member 20 to the belt pulley unit through a transmission shaft 13. The belt pulley unit includes a first pulley 14, a second pulley 15, and a swing wheel 171, the first pulley 14 and the second pulley 15 are in transmission connection by a first synchronous belt 18, the swing wheel 171 is disposed between the first pulley 14 and the second pulley 15, and the swing wheel 171 is disposed to press against an outer side of the first synchronous belt 18 and push a first side of the first synchronous belt 18 towards a second side of the first synchronous belt 18. The swing wheel 171 is disposed on a swing arm 172 configured to swing relative to the first pulley 14 and the second pulley 15, the swing arm 172 is provided with a tension spring, and the tension spring is configured to provide a force for the swing wheel 171 to press against the first synchronous belt 18. By setting the swing wheel 171, the tension of the first synchronous belt 18 can be adjusted in real time. When the rotating cutting blade 33 encounters hard objects causing the second pulley 15 to jam, then the swing wheel 171 will swing to adjust the tension of the first synchronous belt 18, thus preventing the influence of the second pulley 15 on the first pulley 14. Except for the second pulley 15, other components of the driving assembly can operate normally, and the self-propelled mower can still move forward and work normally. After the rotating cutting blade 33 passes over the hard objects, the resistance of the second pulley 15 disappears. Under the action of the swing wheel 171, the tension of the first synchronous belt 18 is restored, and the second pulley 15 returns to normal operation under the drive of the first pulley 14. During the operation process, when the self-propelled mower encounters the hard objects, the transmission mechanism can automatically perform self-protection to prevent component damage, and after the self-propelled mower passes over the hard objects, the transmission mechanism can automatically return to the normal operation, which has strong adaptability. The entire operation process is coherent and smooth without jamming, and the work efficiency is high.

The output shaft 21 of the driving member 20 is arranged horizontally, and the power shaft 31 of the rotating cutting blade 33 is arranged vertically. The gear unit includes a first gear 11 and a second gear 12 meshing with each other, and the first gear 11 and the second gear 12 are bevel gears. The transmission shaft 13 is arranged vertically, the first gear 11 is fixedly connected to the output shaft 21 of the driving member 20, the second gear 12 is fixedly disposed on an upper end of the transmission shaft 13. The first pulley 14 is fixedly disposed on a lower end of the transmission shaft 13. By cooperating the gear unit with the belt pulley unit, a cross-transmission can be achieved, making the layout of the entire driving assembly more rational and compact. Additionally, an output torque of the driving assembly can be adjusted by changing the gear ratio and pulley diameter ratio, which is energy-saving and efficient.

The mowing assembly includes the rotating cutting blade 33, the power shaft 31 of the rotating cutting blade 33 is rotatably assembled on a mounting plate 32, and the second pulley 15 is fixedly sleeved onto the power shaft 31 and disposed below the mounting plate 32. The swing arm 172 includes a rotation end 1721 and an assembly end 1722 opposite to each other, the rotation end 1721 is rotatably assembled on the mounting plate 32, and the swing wheel 171 is disposed to suspend below the assembly end 1722. An end of the tension spring is hooked onto the assembly end 1722, and another end of the tension spring is hooked onto the frame. The above structure layout can fully utilize the assembly space, making the structure of the entire self-propelled mower more compact. A central axis of the swing wheel 171 is parallel to a central axis of the first pulley 14 and a central axis of the second pulley 15, and the swing wheel 171 is disposed close to the first pulley 14. The above settings can increase a swinging torque of the swing wheel 171 and reduce swinging resistance of the swing wheel 171, which allows for a more sensitive response to the jamming of the second pulley 15.

A wheel wall of the swing wheel 171 includes anti-detachment edges 1711 to prevent the first synchronous belt 18 from detaching. The anti-detachment edges 1711 are spaced along an axial direction of the swing wheel 171. The two anti-detachment edges 1711 are respectively located at an upper end and a lower end of the swing wheel 171. The first synchronous belt 18 is pressed against a middle part of the swing wheel 171, and a distance between the two anti-detachment edges is greater than a width of the first synchronous belt 18. This setting allows the first synchronous belt 18 to have some flexibility along the axial direction of the swing wheel 171, thereby preventing jamming.

The moving assembly includes driving wheels 41 disposed at the rear side of the housing 51 and moving wheels 42 disposed at a front side of the housing 51. The belt pulley unit further includes a third pulley 16 in transmission connection to a driving shaft of the driving wheels 41, and the third pulley 16 is drivingly connected to the first pulley 14 through a second synchronous belt 19. The first pulley 14 defines a first pulley groove and a second pulley groove along an axis of the first pulley 14, and the first synchronous belt 18 and the second synchronous belt 19 are respectively disposed in the first pulley groove and the second pulley groove. The swing wheel 171 is configured to eliminate the influence of the second pulley 15 on the first pulley 14, thereby removing the influence of the operating resistance of the rotating cutting blade 33 on the driving wheels 41. The driving wheels 41 and the rotating cutting blade 33 can share a common power source. When the rotating cutting blade 33 encounters the hard objects, the transmission mechanism can automatically perform the self-protection and automatically return to the normal operation, ensuring that the driving wheels 41 can always move steadily. There is no need to frequently shut down and restart, which makes it energy-efficient and highly adaptive.

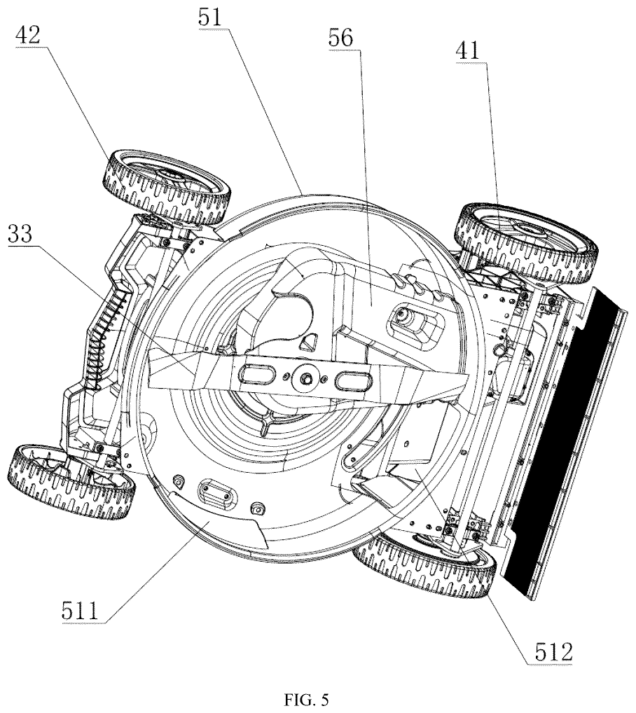

As shown in FIG. 5, the frame includes a housing 51 covering on the rotating cutting blades 33, the housing 51 defines a mowing cavity configured for a rotary operation of the rotating cutting blade 33, and a protective shell 56 is also disposed inside the housing 51 to protect the belt pulley unit. A side wall of the housing defines a first grass outlet communicating with the mowing cavity, and a rear side of the housing 51 defines a second grass outlet 512 communicating with the mowing cavity.

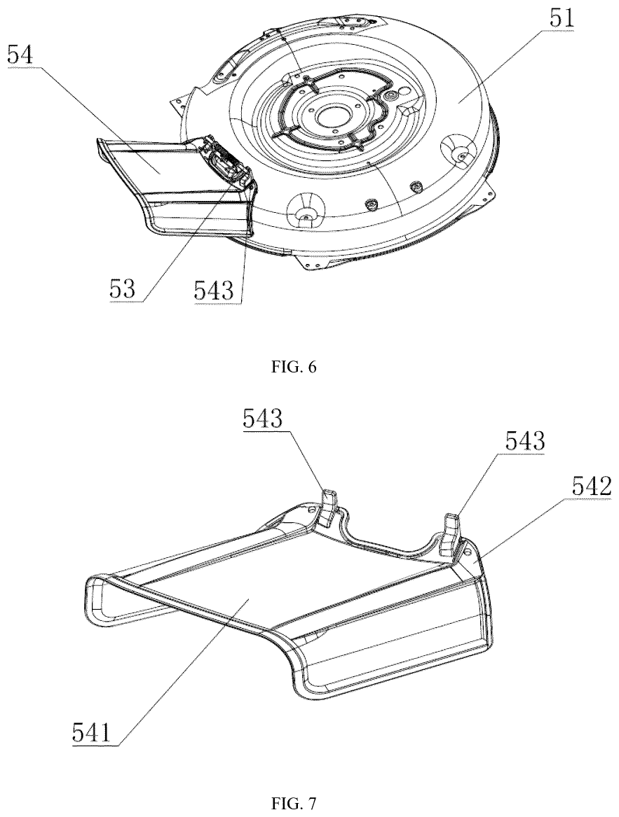

As shown in FIGS. 6-7, the housing 51 is hinged with a first flip cover 52 through an articulated shaft 53, the first flip cover 52 is configured to flip back and forth between a closed position and an open position. the first flip cover 52 covers the first grass outlet 511 when the first flip cover 52 is in the closed position, or the first grass outlet 511 is connected to outside when the first flip cover 52 is in the open position. A first torsion spring is disposed between the first flip cover 52 and the housing 51, and the first torsion spring is configured to provide a force to keep the first flip cover 52 in the closed position. When the first flip cover 52 is in the open position, a slot plate 54 is detachably disposed on the housing 51, the slot plate 54 is positioned corresponding to the first grass outlet 511 and supports the first flip cover 52, thereby keeping the first flip cover 52 in the open position, and the slot plate 54 extends to the outside and defines a slot opening 58 facing downwards. The slot plate 54 can guide the grass during the grass outlet at the side wall of the housing 51 discharging and also serve as a limiting element to support the first flip cover 52, keeping the first flip cover 52 in the open position.

The slot plate 54 includes a U-shaped plate 541 and an extending plate 542 formed on an end of the U-shaped plate 541. The extending plate 542 is superimposed on the housing 51, and hooks 543 are disposed on the extending plate 542 and hooked on the articulated shaft 53. The extending plate 542 is cooperated with the inherent housing 51, and the hooks 543 are cooperated with the inherent articulated shaft 53. This setting allows for assembly without the need for additional fasteners, making the disassembly and assembly process convenient.

The frame further includes an assembling jig 55 disposed at the rear side of the housing 51, a handlebar 70 is disposed at a rear side of the assembling jig 55, and the handlebar 70 is provided with a control lever configured to turn on and turn off the motor 20.

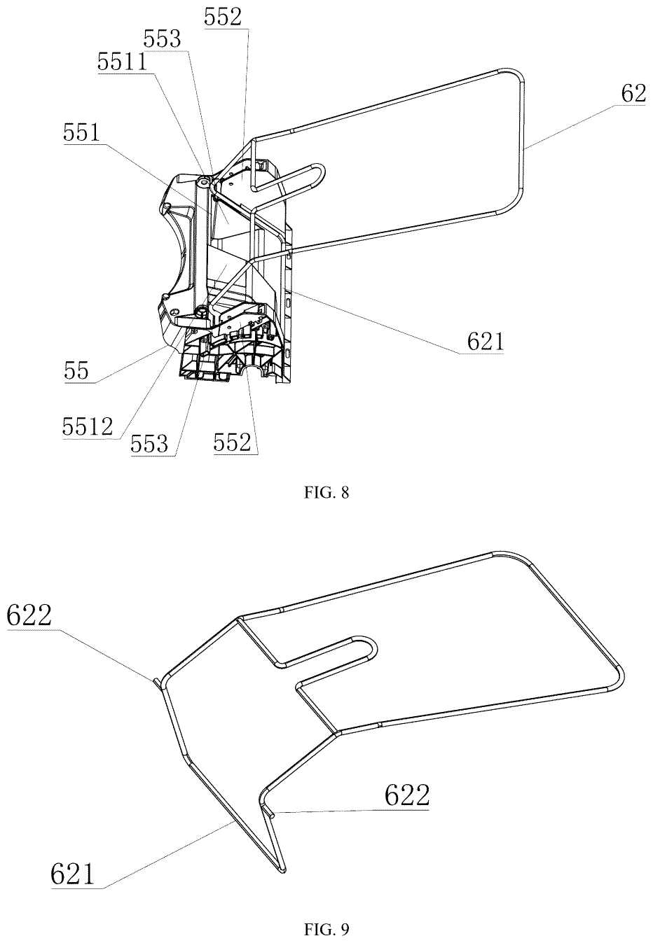

As shown in FIGS. 8-9, the assembling jig 55 defines a grass guiding mouth 5511 communicating with the second grass outlet 512. The assembling jig 55 is hinged with a second flip cover 57, and the second flip cover 57 is configured to flip back and forth between a closed position and an open position. the second flip cover 57 covers the grass guiding mouth 5511 when the second flip cover 57 is in the closed position, or the grass guiding mouth 5511 is communicated with the outside when the second flip cover 57 is in the open position. A second torsion spring is disposed between the second flip cover 57 and the assembling jig 55, and the second torsion spring is configured to provide a force to keep the second flip cover 57 in the closed position. When the second flip cover 57 is in the open position, a grass collection bucket 60 is detachably assembled on the assembling jig 55 and supports the second flip cover 57, thereby keeping the second flip cover 57 in the open position, and a grass intaking mouth 63 of the grass collection bucket 60 is communicated with the grass guiding mouth 5511. The grass collection bucket 60 is capable of collecting grass clippings during the grass outlet at the rear wall of the housing 51 discharging, and it also serves as a positioning element to support the second flip cover 57, keeping it in the open position.

The assembling jig 55 includes a forward leaning plate 551 inclined towards the housing 51 and side plates 552 disposed on two sides of the forward leaning plate 551, the grass guiding mouth 5511 is defined on the forward leaning plate, and a protruding boss 5512 staggered with respect to the grass guiding mouth 5511 is disposed on the forward leaning plate 551. The grass collection bucket 60 includes a flexible bag 61 and a support frame 62 supported on an outer edge of the flexible bag 61, the support frame 62 includes a support rod 621 abutted against an outer edge of the forward leaning plate 551, and hanging rods 622 are symmetrically disposed on two sides of the support rod 621. A junction between the forward leaning plate 551 and the side plates 552 disposed on two sides of the forward leaning plate defines grooves 553 for embedding the hanging rods 622. The support rod 621 is cooperated with the forward leaning plate 551, which provides effective support force for the grass collection bucket 60. The hanging rods 622, cooperated with the grooves 553, prevents the grass collection bucket 60 from tipping downwards. With the cooperation of these structures, the grass collection bucket 60 can be securely mounted without the need for additional fasteners, making the assembly and disassembly process convenient.

When self-propelled mower is in use, the grass outlet at the rear wall of the housing 51 and the grass outlet at the side wall of the housing 51 can be chosen based on actual needs. For discharging at the side wall of the housing 51, the first flip cover 52 is opened and the slot plate 54 is provided to keep the first flip cover 52 in the open position, then the grass collection bucket 60 is removed and the second flip cover 57 is closed. The cut grass is discharged through the first grass outlet 511 through the slot plate 54. For discharging at the rear wall of the housing 51, the second flip cover 57 is opened and the grass collection bucket 60 is provided to keep the second flip cover 57 in the open position, then the slot plate 54 is removed and the first flip cover 52 is closed. The cut grass will enter the grass collection bucket 60 through the second grass outlet 512.

What is claimed is:

1. A self-propelled mower, comprising: a frame, a mowing assembly, a moving assembly and a driving assembly;
wherein the mowing assembly comprises: a rotating cutting blade, and the rotating cutting blade is provided with a power shaft;
wherein the driving assembly comprises: a driving member and a transmission mechanism, the driving member comprises: an output shaft, and the transmission mechanism comprises: a gear unit and a belt pulley unit;
wherein the gear unit is drivingly connected to the output shaft of the driving member, the power shaft of the rotating cutting blade is drivingly connected to the belt pulley unit, and the gear unit is configured to transmit power provided by the driving member to the belt pulley unit through a transmission shaft;
wherein the belt pulley unit comprises a first pulley, a second pulley, and a swing wheel, the first pulley and the second pulley are in transmission connection by a first synchronous belt, the swing wheel is disposed between the first pulley and the second pulley, and the swing wheel is disposed to press against an outer side of the first synchronous belt and push a first side of the first synchronous belt towards a second side of the first synchronous belt; the swing wheel is disposed on a swing arm and configured to swing relative to the first pulley and the second pulley, the swing arm is provided with a tension spring, and the tension spring is configured to provide a force for the swing wheel to press against the first synchronous belt.

2. The self-propelled mower as claimed in claim 1, wherein the output shaft of the driving member is arranged horizontally, and the power shaft of the rotating cutting blade is arranged vertically; the gear unit comprises: a first gear and a second gear meshing with each other, and the first gear and the second gear are bevel gears; the transmission shaft is arranged vertically, the first gear is fixedly connected to the output shaft of the driving member, the second gear is fixedly disposed on an upper end of the transmission shaft, and the first pulley is fixedly disposed on a lower end of the transmission shaft.

3. The self-propelled mower as claimed in claim 2, wherein the power shaft of the rotating cutting blade is rotatably assembled on a mounting plate, and the second pulley is fixedly sleeved onto the power shaft and disposed below the mounting plate; the swing arm comprises:
a rotation end and an assembly end opposite to each other, the rotation end is rotatably assembled on the mounting plate, and the swing wheel is disposed to suspend below the assembly end; an end of the tension spring is hooked onto the assembly end, and another end of the tension spring is hooked onto the frame; a central axis of the swing wheel is parallel to a central axis of the first pulley and a central axis of the second pulley, and the swing wheel is disposed close to the first pulley.

4. The self-propelled mower as claimed in claim 1, wherein the frame comprises a housing covering on the rotating cutting blade, the housing defines a mowing cavity configured for a rotary operation of the rotating cutting blade; a side wall of the housing defines a first grass outlet communicating with the mowing cavity, and a rear side of the housing defines a second grass outlet communicating with the mowing cavity.

5. The self-propelled mower as claimed in claim 4, wherein the housing is hinged with a first flip cover through an articulated shaft, the first flip cover is configured to flip back and forth between a closed position and an open position; and the first flip cover covers the first grass outlet when the first flip cover is in the closed position, or the first grass outlet is connected to outside when the first flip cover is in the open position.

6. The self-propelled mower as claimed in claim 5, wherein a first torsion spring is disposed between the first flip cover and the housing, and the first torsion spring is configured to provide a force to keep the first flip cover in the closed position; when the first flip cover is in the open position, a slot plate is detachably assembled on the housing, the slot plate is positioned corresponding to the first grass outlet and supports the first flip cover, thereby keeping the first flip cover in the open position, and the slot plate extends to the outside and defines a slot opening facing downwards.

7. The self-propelled mower as claimed in claim 6, wherein the slot plate comprises a U-shaped plate and an extending plate formed on an end of the U-shaped plate; the extending plate is superimposed on the housing, and hooks are disposed on the extending plate and hooked on the articulated shaft.

8. The self-propelled mower as claimed in claim 4, wherein the frame further comprises an assembling jig disposed at the rear side of the housing, and the assembling jig defines a grass guiding mouth communicating with the second grass outlet; the assembling jig is hinged with a second flip cover, and the second flip cover is configured to flip back and forth between a closed position and an open position; and the second flip cover covers the grass guiding mouth when the second flip cover is in the closed position, or the grass guiding mouth is communicating with outside when the second flip cover is in the open position.

9. The self-propelled mower as claimed in claim 8, wherein a second torsion spring is disposed between the second flip cover and the assembling jig, and the second torsion spring is configured to provide a force to keep the second flip cover in the closed position; when the second flip cover is in the open position, a grass collection bucket is detachably assembled on the assembling jig and supports the second flip cover, thereby keeping the second flip cover in the open position; and a grass intaking mouth of the grass collection bucket is communicated with the grass guiding mouth.

10. The self-propelled mower as claimed in claim 9, wherein the assembling jig comprises a forward leaning plate inclined towards the housing and side plates disposed on two sides of the forward leaning plate, the grass guiding mouth is defined on the forward leaning plate, and a protruding boss staggered with respect to the grass guiding mouth is disposed on the forward leaning plate; the grass collection bucket comprises a flexible bag and a support frame supported on an outer edge of the flexible bag, the support frame comprises a support rod abutted against an outer edge of the forward leaning plate, and hanging rods are symmetrically disposed on two sides of the support rod; a junction between the forward leaning plate and the side plates disposed on the two sides of the forward leaning plate defines grooves for embedding the hanging rods.
